(19) United States
(12) Patent Application Publication
(10) Pub. No.: US 2019/0190026 A1
(43) Pub. Date: Jun. 20, 2019

(54) CATHODE FOR LITHIUM AIR BATTERY HAVING IMPROVED CAPACITY AND LIFE CYCLE

(71) Applicants: Hyundai Motor Company, Seoul (KR); Kia Motors Corporation, Seoul (KR)

(72) Inventor: Kyoung Jin Jeong, Seoul (KR)

(21) Appl. No.: 16/210,849

(22) Filed: Dec. 5, 2018

(30) Foreign Application Priority Data
Dec. 20, 2017 (KR) 10-2017-0175670

(51) Int. Cl. H01M 4/583; H01M 12/06

(52) U.S. Cl. CPC H01M 4/583; H01M 2004/021; H01M 12/06

(57) ABSTRACT

Disclosed herein is a cathode for a lithium air battery, and to a lithium air battery including the same. Accordingly, the capacity and life cycle of the lithium air battery may be increased.

### CROSS-REFERENCE TO RELATED APPLICATION

This application claims, under 35 U.S.C. § 119(a), the benefit of priority to Korean Patent Application No. 10-2017-0175670 filed on Dec. 20, 2017, the entire contents of which are incorporated herein by reference.

### TECHNICAL FIELD

The present invention relates to a cathode for a lithium air battery and to a lithium air battery including the same.

### BACKGROUND

Due to rapid growth, various problems such as the depletion of fossil fuels, environmental pollution, and global warming have been encountered. Accordingly, renewable energy has been developed, but remarkable achievements have not yet been made.

In the related art, energy storage technology, especially battery technology, has been receiving great attention. For instance, lithium ion batteries have been developed, however, because of low energy density, and the lithium ion batteries have not replaced fossil fuels.

Recently, metal-air batteries, such as lithium air batteries, have been actively studied in many countries such as the U.S.A., Japan, and the like. A lithium air battery uses oxygen, which may be supplied unlimitedly from the air, as an active material, and thus very high theoretical energy density may be obtained. The theoretical energy density of a lithium air battery can be obtained at about 3,200 Wh/kg, which is at least about 10 times greater than a conventional lithium ion battery. Lithium air batteries also have the advantage of being environmentally friendly because they use oxygen as an active material.

However, the lithium ion batteries developed to date have fatal disadvantages of low discharge capacity and overvoltage due to high polarization. For example, lithium peroxide (Li₂O₂) is generated as a discharge product when the battery is discharged, and irregularly accumulates on the surface of the cathode. Since the cathode for the conventional lithium air battery includes a carbon may a dense structure, such as carbon fiber or carbon paper, the flow of oxygen may be obstructed due to the formed discharge product, and thus actual performance becomes much less than theoretical performance.

### SUMMARY OF THE INVENTION

In preferred aspect, provided is a cathode for a lithium air battery, and the cathode may have a structure for increasing the battery capacity.

Another aspect of the present invention provides a cathode for a lithium air battery, such that the life cycle and capacity of the battery may be increased.

The aspects of the present invention are not limited to the foregoing, and will be able to be clearly understood through the following description and to be realized by the means described in the claims and combinations thereof.

In one aspect, the present invention may provide a cathode for a lithium air battery, comprising a carbon substrate comprising carbon foam having a network structure comprising a three-dimensionally connected skeleton and pores in the skeleton, an electrode material coated on a surface of the porous structure, and an air flow path formed in a space of the carbon foam to introduce air into the battery.

As referred herein, a porous structure can include a plurality of pores, such as opened, closed or connected spaces having an internal empty capacity, without limitation to the size or shape of the spaces. Preferred porous structures will permit the inner spaces occupying greater than about 10%, greater than about 20%, greater than about 30%, greater than about 40%, or greater than about 50% of the total volume of the structure. Exemplary sizes of the pores may be, as measured at maximum cross sectional dimension of each pore, from about 10 nm to 100 μm, or from about 100 nm to 100 μm, or more typically from about 1 μm to about 100 μm.

Preferably, the carbon substrate may be carbon foam.

The term “carbon foam” as used herein refers to a carbon material having a network structure including a three-dimensionally connected frame members or skeleton and pores formed between the frame members. The pores may occupy substantial space in the network structure such that carbon atoms may string together to form a loose three-dimensional framework such that the carbon foam may have a substantially reduced density, for example, less than about 10 mg/cm³, less than about 9 mg/cm³, less than about 8 mg/cm³, less than about 7 mg/cm³, less than about 6 mg/cm³, less than about 5 mg/cm³, less than about 4 mg/cm³, less than about 3 mg/cm³, less than about 2 mg/cm³ or less than about 1 mg/cm³. A size of pores in the carbon foam may range in nanometer scale (nanopores), in micrometer scale (micropores), or millimeter scale (macropores), without limitation in the shapes thereof.

The carbon substrate may suitably have a thickness ranging from about 100 μm to less than about 2 mm.

The carbon substrate may suitably have a pore density of about 100 PPI to 500 PPI.

The skeleton may include frame members continuously connected, and the basic unit of the frame members may be a biangular frame, a triangular frame, a rectangular frame, a pentagonal frame or a hexagonal frame.

The carbon foam may include a plurality of hollow open cells in which multiple adjacent basic units are connected to each other.

The electrode material may be selected from the group consisting of graphite, carbon black, Ketjen black, acetylene black, carbon nanotubes, reduced graphene oxide and combinations thereof.

The electrode material may further include a catalyst selected from the group consisting of MnO₂, Co₃O₄, Ru, Ir, RuO₂, Pd, Pt, Bi, Au, Pt₃Co, Ag, FeO, Ru-rGO, RuO₂-rGO, Ir-rGO, Pt₃Co-rGO, FeCo—CNT, FePt—CNT/rGO, RuCo—CNT/rGO, Pd—Ir core-shell nanotubes, AgIr, AuIr and combinations thereof.

The amount of the electrode material may be in the range of about 10 mg/cm³ to 30 mg/cm³.

The size of the flow path may be in the range of about 5 μm to 35 μm.

In addition, the present invention provides a lithium air battery, comprising the cathode as described herein, an anode, and an electrolyte inserted between the cathode and the anode.

Other aspects of the invention are disclosed infra.

According to the present invention, a cathode for a lithium air battery may have a three-dimensional open cell structure to thus retain various pore structures such as macropores and micropores, in which pores having predetermined sizes may be uniformly formed and thus a discharge product may be uniformly formed on the surface and the inside of the cathode. Therefore, retention of a larger amount of the discharge product in the cathode may be obtained, thereby remarkably increasing battery capacity.

Also, according to the present invention, although the discharge product is formed, an air flow path may be sufficiently ensured, whereby an oxygen active material and an electrolyte can easily penetrate into the cathode, such that the battery capacity may be substantially increased. Moreover, overvoltage may not occur, and thus the life cycle of the battery is prolonged.

The effects of the present invention are not limited to the foregoing, and should be understood to include all reasonably possible effects in the following description.

### BRIEF DESCRIPTION OF THE DRAWINGS

FIG. 1 is a cross-sectional view showing a lithium air battery according to an exemplary embodiment of the present invention;

FIG. 2A shows the results of scanning electron microscope (SEM) analysis of carbon foam according to an exemplary embodiment of the present invention, FIG. 2B shows the results of SEM analysis after impregnation of an exemplary carbon foam with an exemplary electrode material according to an exemplary embodiment of the present invention, and FIG. 2C is an enlarged view of FIG. 2B;

FIG. 3A shows an exemplary open cell contained in the carbon foam according to an exemplary embodiment of the present invention, and FIG. 3B shows another exemplary open cell;

FIG. 4A shows an SEM image of an exemplary carbon foam of Example 1-1 according to an exemplary embodiment of the present invention, and FIG. 4B shows an SEM image of an exemplary cathode manufactured by loading an exemplary electrode material in the carbon foam of Example 1-1;

FIG. 5A shows an SEM image of an exemplary carbon foam of Example 1-3 according to an exemplary embodiment of the present invention, and FIG. 5B shows an exemplary SEM image of an exemplary cathode manufactured by loading an exemplary electrode material in the carbon foam of Example 1-3; and

FIG. 6A shows an SEM image of the carbon foam of Comparative Example 1, and FIG. 6B shows an SEM image of a cathode manufactured by loading an electrode material in the carbon foam of Comparative Example 1.

### DETAILED DESCRIPTION

The above and other aspects, features and advantages of the present invention will be more clearly understood from the following preferred embodiments taken in conjunction with the accompanying drawings. However, the present invention is not limited to the embodiments disclosed herein, but may be modified into different forms. These embodiments are provided to thoroughly explain the invention and to sufficiently transfer the spirit of the present invention to those skilled in the art.

Throughout the drawings, the same reference numerals will refer to the same or like elements. For the sake of clarity of the present invention, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a first element discussed below could be termed a second element without departing from the scope of the present invention. Similarly, the second element could also be termed a first element. As used herein, the singular forms are intended to include the plural forms as well, unless the context clearly indicates otherwise.

It will be further understood that the terms “comprise”, “include”, “have”, etc. when used in this specification specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it can be directly on the other element, or intervening elements may be present therebetween. In contrast, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are taken to mean that these numbers are approximations including various uncertainties of the measurements that essentially occur in obtaining these values among others, and thus should be understood to be modified by the term “about” in all cases. Furthermore, when a numerical range is disclosed in this specification, such a range is continuous and includes all values from the minimum value of said range to the maximum value thereof, unless otherwise indicated. Moreover, when such a range refers to an integer, all integers including the minimum value to the maximum value are included unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between the valid integers within the stated range, such as 5.5, 6.5, 7.5, 5.5 to 8.5, 6.5 to 9, and the like. Also, for example, the range of “10% to 30%” will be understood to include any subranges, such as 10% to 15%, 12% to 18%, 20% to 30%, etc., as well as all integers including values of 10%, 11%, 12%, 13% and the like and up to 30%, and will also be understood to include any value between the valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, a detailed description will be given of various exemplary embodiments of the present invention.

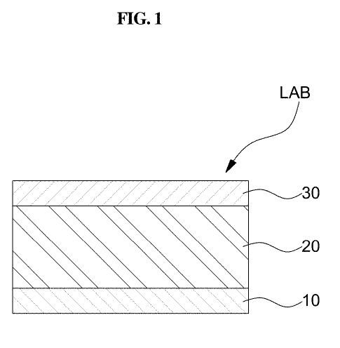

FIG. 1 is a cross-sectional view showing an exemplary lithium air battery according to an exemplary embodiment of the present invention.

With reference to FIG. 1, the lithium air battery (LAB) according to an exemplary embodiment of the present invention may include a cathode 30, an anode 10 and an electrolyte 20. The lithium air battery (LAB) may be a battery system using lithium as the anode 10 and using oxygen in air as the active material for the cathode 30. In the anode 10, oxidation and reduction of lithium may occur, and in the cathode 30, reduction and oxidation of oxygen introduced from the outside occur.

Chemical Schemes 1 and 2 below show reactions at the anode 10 and the cathode 30 upon discharge of the lithium air battery (LAB).

(Anode): Li→Li⁺+e⁻ [Chemical Scheme 1]

(Cathode): 2Li⁺+O₂+2e⁻→Li₂O₂ [Chemical Scheme 2]

As shown schematically shown in Chemical Schemes 1 and 2, lithium metal of the anode 10 is oxidized to thus produce lithium ions and electrons. The lithium ions are transferred to the cathode 30 through the electrolyte 20, and the electrons are transferred to the cathode 30 through the current collector and the external conductive line. The cathode 30 is porous and thus external air may be introduced thereto. Oxygen contained in the external air is reduced by the electrons in the cathode 30, and Li₂O₂ is formed as a discharge product.

A charge reaction is carried out in the direction opposite thereto. As shown in Chemical Scheme 3 below, Li₂O₂ is decomposed at the cathode 30, thus producing lithium ions and electrons.

(Cathode) Li₂O₂→2Li⁺+O₂+2e⁻ [Chemical Scheme 3]

The electrolyte 20 may be inserted impregnated between the cathode 30 and the anode 10. The electrolyte 20 may include a solid electrolyte. The electrolyte 20 may contain a lithium salt. For example, the lithium salt may be dissolved in a solvent, and may act as a supply source of lithium ions in the battery, and may play a role in promoting the transfer of lithium ions between the anode 10 and the electrolyte 20.

The lithium salt is not particularly limited, and may include any electrolyte material used in the related art. The electrode material may suitably include at least one selected from the group consisting of, for example, LiPF₆, LiBF₄, LiSbF₆, LiAsF₆, LiN(SO₂C₂F₅)₂, Li(CF₃SO₂)₂N, LiC₄F₉SO₃, LiClO₄, LiAlO₂, LiAlCl₄, LiF, LiBr, LiCl, LiI, LiB(C₂O₄)₂, LiCF₃SO₃, LiN(SO₂CF₃)₂(LiTFSI), LiN(SO₂C₂F₅)₂ and LiC(SO₂CF₃)₃.

The main factors promoting degradation of the lithium air battery are as follows.

1) As shown in Chemical Scheme 4 below, when the discharge product (Li₂O₂) reacts with carbon (C) as the cathode, an insulation layer (Li₂CO₃) is formed on the surface thereof, and thus electron transfer is obstructed.

Li₂O₂+C Li₂CO₃ [Chemical Scheme 4]

2) The electrolyte is decomposed to thus form a byproduct, which obstructs the transfer of electrons or lithium ions.

3) The discharge product blocks pores in the cathode to thus obstruct the transfer of oxygen.

Accordingly, the present invention may prevent the transfer of oxygen from being obstructed by blockage of the pores in the cathode by the discharge product, and the pore size of the cathode may be increased and pores having different sizes may be formed.

Below is a detailed description of the cathode 30 for the lithium air battery according to the present invention.

The cathode 30 may include a carbon substrate having porous structure, or particularly, a carbon foam having a network structure including a three-dimensionally connected skeleton or frame members, and pores therein. An electrode material may be coated on a surface of the porous structure, such as on the surface of the skeleton or frame members, and filled in the pores. The cathode may include an air flow path that may introduce air into the battery.

1. Carbon Foam

The carbon foam may be a structural body that constitutes the framework of the cathode to thus provide space for immobilizing the electrode material in the cathode. Specifically, the carbon foam may form of a network structure comprising a three-dimensionally connected skeleton (frame members) and pores in the skeleton.

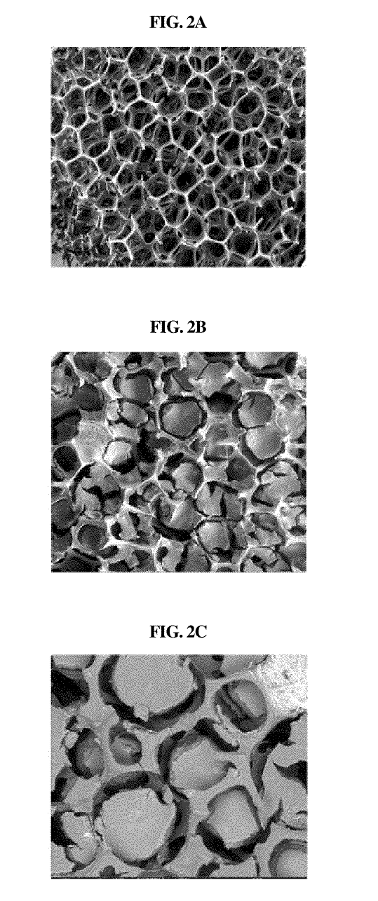

FIG. 2A shows the SEM image of the carbon foam according to an embodiment of the present invention. With reference thereto, the carbon foam may include frame members continuously connected, and the basic unit of which may be a biangular frame, a triangular frame, a rectangular frame, a pentagonal frame or a hexagonal frame, and multiple basic units adjacent to each other are connected to thus form hollow open cells.

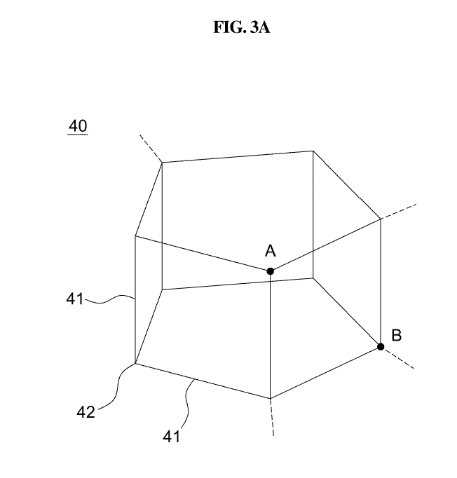

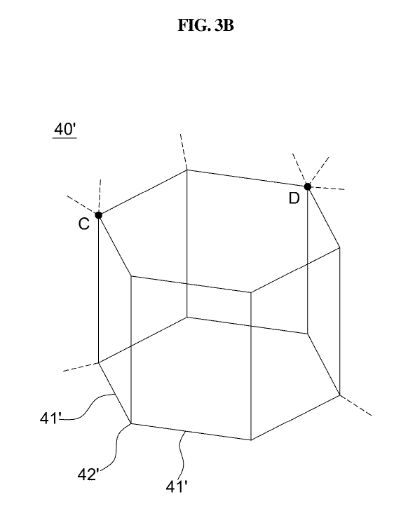

FIG. 3A shows an exemplary open cell 40 contained in the carbon foam according to an exemplary embodiment of the present invention, and FIG. 3B shows another exemplary open cell 40′.

FIGS. 3A and 3B show the open cells 40, 40′ and the carbon foam formed therewith, and the open cells 40, 40′ are not necessarily limited to the shapes of FIGS. 3A and 3B. The open cell may have any shape.

In FIGS. 3A and 3B, the full lines present the frame members belonging to the open cells 40, 40′, and the dotted lines present the frame members not belonging to the open cells 40, 40′.

With reference to FIGS. 3A and 3B, the skeleton of the carbon foam according to an exemplary embodiment of the present invention may include the frame members 41, 41′ continuously connected. The basic unit of the carbon foam may include the frame members 41, 41′ and the center points 42, 42′ at which the frame members 41, 41′ come into contact with each other. Depending on the number of frame members 41, 41′ abutting the center points 42, 42′, the basic unit may be classified into a biangular frame (not shown), a triangular frame (A of FIG. 3A), a rectangular frame (B of FIG. 3A), a pentagonal frame (C of FIG. 3B) or a hexagonal frame (D of FIG. 3B).

The carbon foam may have a thickness ranging from about 100 μm to less than about 2 mm. When the carbon foam in thin film form is used in this way, the cathode may be formed to be considerably thin, and thus the energy density per volume of the lithium air battery may be remarkably increased.

In the present invention, the carbon foam in thin film form having a thickness on the order of micrometers may be suitably used, the carbon foam may have a dual pore structure of macropores and micropores. The carbon form may have the pore density of about 100 PPI to 500 PPI so that the pores may be uniformly distributed.

2. Electrode Material

The electrode material may be a carbon-based material selected from the group consisting of graphite, carbon black, Ketjen black, acetylene black, carbon nanotubes (CNTs), reduced graphene oxide (rGO) and combinations thereof.

The carbon-based material as used herein may be a conductive additive that imparts conductivity to the cathode. When the battery is discharged, the discharge product may be formed through the reaction of oxygen introduced into the cathode, lithium ions, and electrons on the carbon-based material.

Since the above reaction occurs with an increase in the specific surface area of the carbon-based material, the carbon-based material may be coated on the surface of the skeleton of the carbon foam and may be filled in the pores of the carbon foam.

For example, the carbon foam as shown in FIG. 2A may be impregnated with the carbon-based material, thus forming the cathode shown in FIG. 2B. With reference to FIG. 2B, the carbon-based material may be applied not only on the skeleton of the carbon foam but also in the pores. With reference to FIG. 2C, the skeleton of the carbon foam may be uniformly coated with the carbon-based material.

As shown in FIGS. 2A to 2C, the pores may be filled through application of the carbon-based material, and thus, unless the amount of the carbon-based material is appropriately adjusted, the discharge product may not be formed in the cathode but may accumulate only on the surface thereof. Furthermore, the air and/or the electrolyte may not efficiently penetrate into the cathode.

When the pore density of the carbon foam is about 100 PPI to 500 PPI and the thickness thereof falls in the range of from about 100 μm to less than about 2 mm, loading of the carbon-based material may suitably be in an amount of about 10 mg/cm³ to 30 mg/cm³. When the amount of the carbon-based material is about 10 mg/cm³ to 30 mg/cm³, uniform coating and filling of the carbon foam may be obtained, thereby increasing the specific surface area.

The electrode material may further include a catalyst in addition to the carbon-based material. The catalyst may include a catalyst that promotes the decomposition of the discharge product, a catalyst that promotes the formation of the discharge product, or combinations thereof For example, the catalyst may suitably be selected from the group consisting of MnO₂, Co₃O₄, Ru, Ir, RuO₂, Pd, Pt, Bi, Au, Pt₃Co, Ag, FeO, ruthenium supported on reduced graphene oxide (Ru-rGO), ruthenium oxide supported on reduced graphene oxide (RuO₂-rGO), iridium supported on reduced graphene oxide (Ir-rGO), Pt₃Co supported on reduced graphene oxide (Pt₃Co-rGO), FeCo supported on carbon nanotubes (FeCo—CNT), FePt supported on carbon nanotubes and reduced graphene oxide (FePt—CNT/rGO), RuCo supported on carbon nanotubes and reduced graphene oxide (RuCo—CNT/rGO), Pd—Ir core-shell nanotubes, AgIr, AuIr and combinations thereof.

3. Air Flow Path

The air flow path is a passage that enables the air introduced into the battery from the outside to flow in the cathode. As shown in FIG. 2C, the air flow path may be the empty space between the electrode material coated on the skeleton of the carbon foam and the electrode material placed in the pores of the carbon foam.

The size of the air flow path may range from about 5 μm to about 35 μm. Here, the size of the air flow path may be defined as the diameter when the air flow path is formed in a virtual cylinder in the cathode, or may indicate the distance between the electrode material coated on the skeleton of the carbon foam and the electrode material placed in the pores.

In certain preferred aspect, the pore density of the carbon foam and the amount of the electrode material (carbon-based material) may be suitably adjusted to thus ensure an air flow path having a size of about 5 μm to 35 μm, and thereby, even when the discharge product is formed in the cathode, the flow of air may not be obstructed, and the penetration rate of air and/or electrolyte may be improved.

### EXAMPLE

A better understanding of the present invention will be given through the following examples, which are merely set forth to illustrate, but are not to be construed as limiting the present invention.

### Example 1 and Comparative Example 1

(1) Preparation of Cathode

As an electrode material, Ketjen black (KB600J, made by Lion, Japan) was used, and a dispersion solvent such as N-methylpyrrolidone (NMP) and a PVP-based dispersant for increasing dispersion stability of the electrode material were added thereto, thus preparing a slurry. Carbon foam was impregnated with the slurry, followed by drying in a vacuum oven at a temperature of 110° C. for 12 hr.

The pore density and thickness of the carbon foam and the amount of loaded electrode material are shown in Table 1 below.

TABLE 1

| | | Example | Example | Example | Example | Example | Example | Comparative |
|---|---|---|---|---|---|---|---|---|
| | Unit | 1-1 | 1-2 | 1-3 | 1-4 | 1-5 | 1-6 | Example 1 |
| Pore density | PPI | 100 | 200 | 250 | 300 | 400 | 500 | 750 |
| of carbon | | | | | | | | |
| foam | | | | | | | | |
| Thickness of | μm | 800 | | | | | | |
| carbon foam | | | | | | | | |
| Amount of | mg/cm³ | 10.53 | 12.23 | 15.80 | 17.57 | 21.23 | 25.65 | 32.78 |
| loaded | | | | | | | | |
| electrode | | | | | | | | |
| material | | | | | | | | |

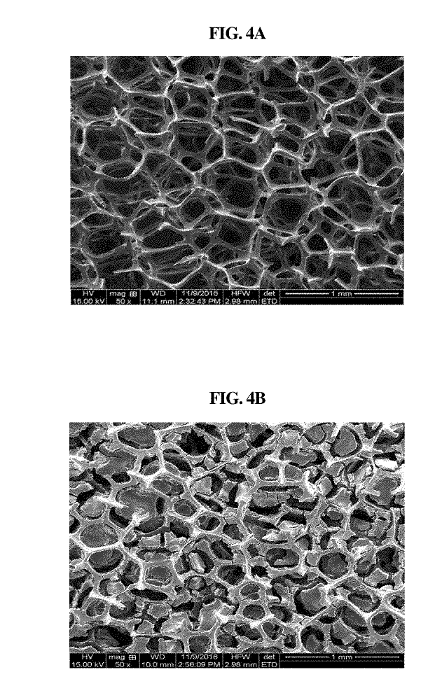

FIG. 4A shows an SEM image of the carbon foam of Example 1-1, and FIG. 4B shows an SEM image of an exemplary cathode manufactured by loading an exemplary electrode material in an exemplary carbon foam of Example 1-1.

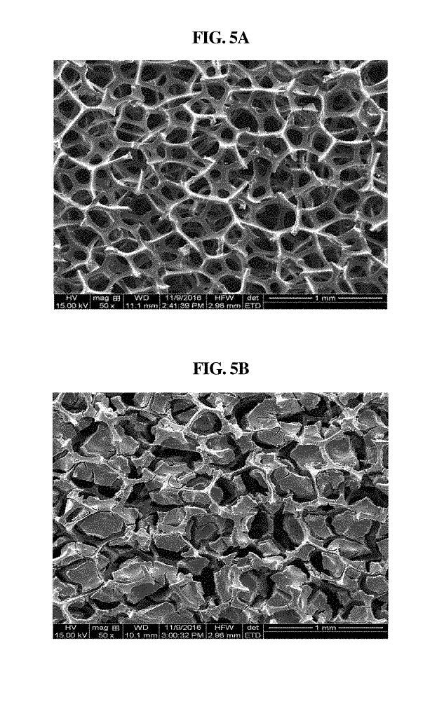

FIG. 5A shows an SEM image of an exemplary carbon foam of Example 1-3, and FIG. 5B shows an SEM image of an exemplary cathode manufactured by loading an exemplary electrode material in the carbon foam of Example 1-3.

With reference to FIGS. 4A, 4B, 5A and 5B, the pore density of the carbon foam and the amount of loaded electrode material were observed to fall within the ranges of the present invention, whereby the skeleton of the carbon foam was uniformly coated with the electrode material and the pores of the carbon foam were also uniformly filled therewith.

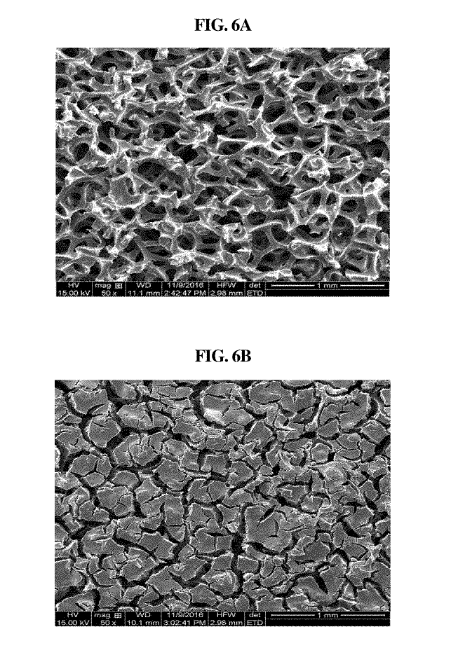

FIG. 6A shows an SEM image of the carbon foam of Comparative Example 1, and FIG. 6B shows an SEM image of a cathode manufactured by loading an electrode material in the carbon foam of Comparative Example 1. With reference thereto, in Comparative Example 1, the pore density of the carbon foam and the amount of loaded electrode material were observed to fall outside of the range of the present invention, whereby the cathode was made too dense.

(2) Manufacture of Lithium Air Battery

As an anode, lithium foil having a thickness of about 500 μm was used, and a glass fiber as a separator and a SUS plate having a thickness of 500 μm as an anode current collector were used. The battery was configured to include the anode current collector, the lithium anode, the separator and the cathode, which were stacked upwards, and 800 μL of diethylene glycol diethyl ether (DEGDEE) as an electrolyte was injected between the cathode and the anode, followed by pressing, thus forming a coin-cell-shaped lithium air battery.

(3) Evaluation of Capacity of Lithium Air Battery

The discharge capacity of the lithium air batteries of Examples 1-1 to 1-6 and Comparative Example 1 was measured. For example, the discharge capacity was measured while a constant current of 0.25 mA/cm² was applied to each lithium air battery. The results are shown in Table 2 below.

TABLE 2

| | No. | | | | | | |
|---|---|---|---|---|---|---|---|
| | | | | | | | Comparative |
| | Example 1-1 | Example 1-2 | Example 1-3 | Example 1-4 | Example 1-5 | Example 1-6 | Example 1 |
| Capacity | 22 | 27 | 35 | 33~37 | 29~32 | 30~33 | Not |
| [mAh/cm²] | | | | | | | operating |

The discharge capacity measured in the same manner as above was about 3.5 mAh/cm² in the aforementioned Patent Document (Korean Patent No. 10-1684015). Compared thereto, the capacity of the lithium air batteries of Examples 1-1 to 1-6 was remarkably improved.

The lithium air battery of Comparative Example 1 did not operate. It can be confirmed that the pore density of the carbon foam has to satisfy the range of 100 PPI to 500 PPI under the condition that the thickness of the carbon foam is from 100 μm to less than 2 mm.

### Example 2

(1) Preparation of Cathode

As an electrode material, Ketjen black (KB600J, made by Lion, Japan) was used, and a dispersion solvent such as N-methylpyrrolidone (NMP) and a PVP-based dispersant for increasing the dispersion stability of the electrode material were added thereto, thus preparing a slurry. Carbon foam was impregnated with the slurry, followed by drying in a vacuum oven at a temperature of 110° C. for 12 hr.

The carbon foam had a pore density of 250 PPI and a thickness of 800 μm, and the amount of loaded electrode material was 15.80 mg/cm³.

(2) Manufacture of Lithium Air Battery

As an anode, lithium foil having a thickness of about 500 μm was used, and a glass fiber as a separator and a SUS plate having a thickness of 500 μm as an anode current collector were used. The battery was configured to include the anode current collector, the lithium anode, the separator and the cathode, which were stacked upwards, and 800 μL of diethylene glycol diethyl ether (DEGDEE) as an electrolyte was injected between the cathode and the anode, followed by pressing, thus forming a coin-cell-shaped lithium air battery.

(3) Evaluation of Life Cycle of Lithium Air Battery

The life cycle of the lithium air battery of Example 2 was evaluated. The lithium air battery was repetitively charged and discharged in 1 mA/cm² and 5 mA/cm² capacity cut-off manners in the ranges of constant-current constant-voltage charging (4.6V cut-off) and constant-current discharging (2.0V cut-off) at a current density of 0.25 mA/cm².

When the lithium air battery was charged and discharged in a 1 mA/cm² cut-off manner, a battery voltage of 2.5 V or more was exhibited up to 100 cycles and there was no change in discharge capacity. This means that the reversibility of charge/discharge reactions was maintained for up to 100 cycles.

Also, when the lithium air battery was charged and discharged in a 5 mA/cm² cut-off manner, a battery voltage of 2 V or more was exhibited up to 15 cycles and the reversibility of charge/discharge reactions was maintained for up to 15 cycles.

Although the various exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A cathode for a lithium air battery, comprising:
a carbon foam comprising a three-dimensionally connected skeleton and pores;
an electrode material coated on a surface of the skeleton and filled in the pores; and
an air flow path formed in a space of the carbon foam to introduce air into the battery.

2. The cathode of claim 1, wherein the carbon foam has a thickness ranging from about 100 μm to less than about 2 mm.

3. The cathode of claim 1, wherein the carbon foam has a pore density of 100 PPI to 500 PPI.

4. The cathode of claim 1, wherein the skeleton comprises frame members continuously connected, a basic unit of the frame members is a biangular frame, a triangular frame, a rectangular frame, a pentagonal frame or a hexagonal frame.

5. The cathode of claim 4, wherein the carbon foam comprises a plurality of hollow open cells in which multiple adjacent basic units are connected to each other.

6. The cathode of claim 1, wherein the electrode material is selected from the group consisting of graphite, carbon black, Ketjen black, acetylene black, carbon nanotubes, reduced graphene oxide and combinations thereof.

7. The cathode of claim 1, wherein the electrode material further comprises a catalyst selected from the group consisting of MnO₂, Co₃O₄, Ru, Jr, RuO₂, Pd, Pt, Bi, Au, Pt₃Co, Ag, FeO, Ru-rGO, RuO₂-rGO, Ir-rGO, Pt₃Co-rGO, FeCo—CNT, FePt—CNT/rGO, RuCo—CNT/rGO, Pd—Ir core-shell nanotubes, AgIr, AuIr and combinations thereof.

8. The cathode of claim 1, wherein an amount of the electrode material is in a range of about 10 mg/cm³ to 30 mg/cm³.

9. The cathode of claim 1, wherein a size of the air flow path is in a range of about 5 μm to 35 μm.

10. A lithium air battery, comprising:
a cathode of claim 1;
an anode; and
an electrolyte inserted between the cathode and the anode.
